(19) United States
(12) Patent Application Publication
(10) Pub. No.: US 2018/0024685 A1
(43) Pub. Date: Jan. 25, 2018

(54) TOUCH-SENSITIVE INPUT APPARATUS, ELECTRONIC APPARATUS AND TOUCH-SENSITIVE INPUT METHOD

(71) Applicant: PEGATRON CORPORATION, Taipei City (TW)

(72) Inventor: YU-FENG KUO, Taipei City (TW)

(21) Appl. No.: 15/650,247

(22) Filed: Jul. 14, 2017

(30) Foreign Application Priority Data
Jul. 21, 2016 (TW) 105123033

(51) Int. Cl. G06F 3/041; G06F 3/01

(52) U.S. Cl. CPC G06F 3/0414; G06F 3/016; G06F 2203/04105

(57) ABSTRACT

A touch-sensitive input apparatus includes an input device, at least one piezoelectric device and a circuit board. The piezoelectric device contacts the input device and receives a pressure from the input device to deform and generate an output voltage. The circuit board electrically connects with the piezoelectric device and includes a processing module and a power supply module. The processing module electrically connects with the piezoelectric device and receives the output voltage, the processing module calculates a pressure value corresponding to the pressure according the output voltage, and outputs an execution event when the pressure value exceeding a predetermined pressure value. The power supply module is electrically connected with the processing module and the piezoelectric device and outputs an alternate current to the piezoelectric device according to the execution event, so that the piezoelectric device generates tensile deformations and compression deformations alternately to drive the input device to generate vibration.

### CROSS-REFERENCE TO RELATED APPLICATIONS

This application claims the priority benefits of Taiwan Patent Application No. 105123033, filed on Jul. 21, 2016. The entirety of the above-mentioned patent applications are hereby incorporated by references herein and made a part of specification.

### BACKGROUND

### Technology Field

The invention relates to a touch-sensitive input apparatus, an electronic apparatus and a touch-sensitive input method and, in particular, to a touch-sensitive input apparatus with haptic feedback functionality, an electronic apparatus including the touch-sensitive input apparatus, and a touch-sensitive input method based on the touch-sensitive input apparatus.

### Related Art

With the development of science and technology, to add more interactive modes between an electronic apparatus and a user, except for input devices for the input of the users such as a physical or virtual keyboard, many electronic devices include additional haptic feedback components. The haptic feedback components are usually disposed at an area near the housing of an electronic apparatus, and make a portion of the electronic apparatus generate vibrations, so that the user can feel the vibrations to achieve the objective of feedback or interaction.

Generally speaking, an input apparatus may have a pressure sensor, such as a capacitive, resistive or strain gauge-type force sensor, to detect the input action of a user. Currently, the electronic apparatus with haptic feedback functionality includes an actuator inside the electronic apparatus to generate vibrations through the actuator.

However, the current design trend for the electronic apparatus is light and compact. No matter what type of the pressure sensor and the actuator are used, two different components, the pressure sensor and the actuator, are required to be disposed in the electronic apparatus, which occupies different spaces and contradicts to the current space-saving design trend. Using different components further increases the material costs.

### SUMMARY

An objective of the invention is to provide a touch-sensitive input apparatus, an electronic apparatus and a touch-sensitive input method, which connects a piezoelectric device to an input device and a circuit board and use the mechanical energy-electrical potential conversion characteristic of the piezoelectric device to achieve two functions of detecting the input action and providing a vibration feedback simultaneously to save space and reduce material costs.

To achieve the objective mentioned above, the invention provides a touch-sensitive input apparatus, including an input device, at least one piezoelectric device and a circuit board. The piezoelectric device contacts the input device and can receive a pressure from the input device to deform and generate an output voltage. The circuit board is electrically connected with the piezoelectric device, and includes a processing module and a power supply module. The processing module is electrically connected with the piezoelectric device, receives the output voltage, calculates a pressure value corresponding to the pressure according the output voltage, and outputs an execution event when the pressure value exceeding a predetermined pressure value. The power supply module outputs an alternate current to the at least one piezoelectric device according to the execution event, making the piezoelectric device generate tensile deformations and compression deformations alternately to drive the input device to generate vibration.

To achieve the objective mentioned above, the invention further provides an electronic apparatus including a touch-sensitive input apparatus. The touch-sensitive input apparatus includes an input device, at least one piezoelectric device and a circuit board. The piezoelectric device contacts the input device and can receive a pressure from the input device to deform and generate an output voltage. The circuit board is electrically connected with the piezoelectric device, and includes a processing module and a power supply module. The processing module is electrically connected with the piezoelectric device, receives the output voltage, calculates a pressure value corresponding to the pressure according the output voltage, and outputs an execution event when the pressure value exceeding a predetermined pressure value. The power supply module outputs an alternate current to the at least one piezoelectric device according to the execution event, making the piezoelectric device generate tensile deformations and compression deformations alternately to drive the input device to generate vibration.

According to one embodiment of the invention, the execution event includes opening an application program.

According to one embodiment of the invention, the execution event includes controlling an output voltage and an output time interval of the alternate current to control a vibration amplitude and a vibration frequency of the piezoelectric device.

According to one embodiment of the invention, the piezoelectric device includes a piezoelectric sheet, at least two electrodes and a metal sheet, the piezoelectric sheet is attached to the metal sheet, and the at least two electrodes are disposed at the piezoelectric sheet and the metal sheet, respectively.

According to one embodiment of the invention, the piezoelectric device has two electrodes, the two electrodes are disposed at the piezoelectric sheet and the metal sheet, respectively, and the processing module and the power supply module are electrically connected with the two electrodes.

According to one embodiment of the invention, the piezoelectric device has four electrodes, the four electrodes includes two first electrodes and two second electrodes, the two first electrodes are disposed at the piezoelectric sheet and the metal sheet, respectively, the two second electrodes are disposed at the piezoelectric sheet and the metal sheet, respectively, the processing module is electrically connected with the two first electrodes, and the power supply module is electrically connected with the two second electrodes.

According to one embodiment of the invention, the polarity of the at least one electrode disposed at the piezoelectric sheet and the polarity of the at least one electrode disposed at the metal sheet are positive and negative, respectively.

According to one embodiment of the invention, the piezoelectric device includes a free end and a fixed end, the free end is movably connected with the input device, the fixed end is fixed at the circuit board, and the free end of the piezoelectric device is capable of receiving the pressure from the input device whereby the piezoelectric device is compressively deformed.

According to one embodiment of the invention, the input device further includes a connecting member, the free end of the piezoelectric device is movably connected with the connecting member, the circuit board further includes a fixing member, and the fixed end of the piezoelectric device is fixed at the fixing member.

According to one embodiment of the invention, the piezoelectric device further includes a weight member disposed between the free end and the fixed end.

According to one embodiment of the invention, the piezoelectric device includes a free end and a fixed end, the fixed end is fixed at the input device, the free end is disposed opposite to the fixed end, the circuit board is connected between the free end and the fixed end, and the fixed end of the piezoelectric device is capable of receiving the pressure from the input device whereby the piezoelectric device is compressively deformed.

According to one embodiment of the invention, the circuit board further includes a connecting member, the connecting member is connected with the piezoelectric device, and the connecting member is connected between the free end and the fixed end, the input device further comprises a fixing member, the fixed end of the piezoelectric device is fixed at the fixing member.

According to one embodiment of the invention, the piezoelectric device further includes a weight member disposed at the free end of the piezoelectric device.

According to one embodiment of the invention, the input device is a touchpad or a touch panel.

To achieve the objective mentioned above, the invention further provides a touch-sensitive input method for the touch-sensitive input apparatus mentioned above. The touch-sensitive input method includes the following steps of: the piezoelectric device receiving a pressure from the input device to deform and generate an output voltage; the processing module receiving the output voltage and calculating a pressure value corresponding to the pressure according the output voltage; the processing module outputting an execution event when the pressure value exceeding a predetermined pressure value; the power supply module outputting an alternate current to the piezoelectric device according to the execution event; and the piezoelectric device generating tensile deformations and compression deformations alternately to drive the input device to generate vibration.

To sum up, according to the touch-sensitive input apparatus and the electronic apparatus, an input action at the input device is detected by making the piezoelectric device contact the input device and be connected with the circuit board to convert the mechanical energy (the compression deformation) into electrical potential (output voltage), and a haptic feedback is achieved by using the piezoelectric device to convert the electric potential into mechanical energy (tensile and compression deformations) to make the input device generate vibrations. Therefore, the input device of the invention achieves the two functions of input action detection and haptic feedback simultaneously using the piezoelectric device to replace conventional force sensors and actuators, which saves spaces and reduces material costs.

### BRIEF DESCRIPTION OF THE DRAWINGS

FIG. 1 is a schematic diagram of the touch-sensitive input apparatus according to a first embodiment of the invention.

FIG. 2A is a schematic diagram of the piezoelectric device shown in FIG. 1.

FIG. 2B and FIG. 2C are schematic diagrams showing the actions of the piezoelectric device shown in FIG. 2A when receiving alternating current.

FIG. 3A is a flowchart of the touch-sensitive input method according to an embodiment of the invention.

FIG. 3B is a schematic diagram showing the touch-sensitive input apparatus shown in FIG. 1 performing the input function.

FIG. 3C is a schematic diagram showing the touch-sensitive input apparatus shown in FIG. 1 performing the haptic feedback function.

FIG. 4 is a schematic diagram showing the piezoelectric device shown in FIG. 2A according to another embodiment.

FIG. 5 is a schematic diagram shown the touch-sensitive input apparatus according to a second embodiment of the invention.

FIG. 6 is a schematic diagram showing the touch-sensitive input apparatus according to a third embodiment of the invention.

FIG. 7 is a schematic diagram showing the touch-sensitive input apparatus according to a fourth embodiment of the invention.

### DETAILED DESCRIPTION OF THE EMBODIMENT

The present invention will be apparent from the following detailed description, which proceeds with reference to the accompanying drawings, wherein the same references relate to the same elements.

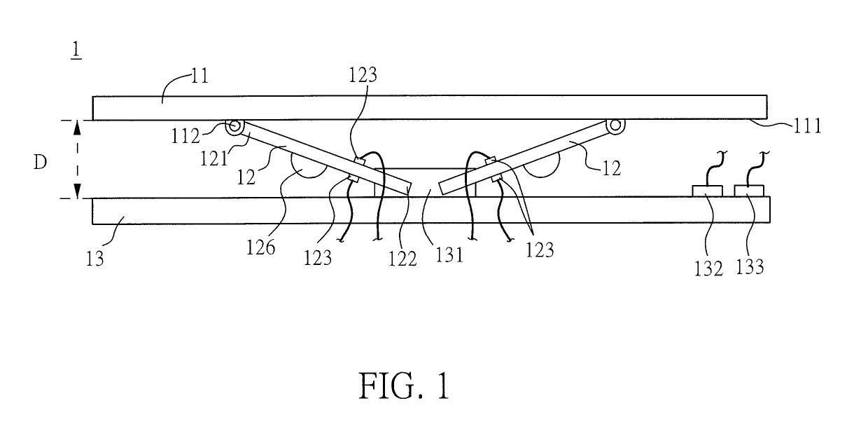

FIG. 1 is a schematic diagram of the touch-sensitive input apparatus according to a first embodiment of the invention. Referring to FIG. 1, the touch-sensitive input apparatus 1 can be a stand-alone electronic apparatus which can be electrically connected with other electronic apparatus such as a computer, a mobile phone or a tablet PC. The touch-sensitive input apparatus 1 can also be assembled with an electronic apparatus to form an electronic apparatus with haptic feedback functionality, such as a smart phone, a smart watch, a tablet PC or a touch screen with haptic feedback functionality.

The touch-sensitive input apparatus 1 includes an input device 11, at least one piezoelectric device 12 and a circuit board 13. The input device 11 of the present embodiment is a device for a user to perform an input action. Specifically, the user can perform an input action by pressing the input device 11, that is, by applying a pressure to the input device 11. Preferably, the input device 11 can be a touch pad or a touch panel.

The piezoelectric device 12 of the present embodiment contacts the input device 11. Specifically, one or more piezoelectric device 12 can be disposed at the inner surface of the input device 11, and one end of the piezoelectric device 12 is connected with the input device 11. In detail, one or more piezoelectric devices 12 can be selected to be disposed at the inner surface 111 of a specific region (such as one of the four side regions) of the input device 11. In the present embodiment, two piezoelectric devices 12 are disposed, as shown in FIG. 1. Furthermore, one can dispose piezoelectric devices 12 at the inner surfaces of multiple specific regions (such as the four side regions) of the input device 11. The invention is not so limited.

In the present embodiment, the piezoelectric device 12 includes a free end 121 and a fixed end 122. The free end 121 and the fixed end 122 are located at two opposite ends of the piezoelectric device 12. The free end 121 is movably connected with the input device 11, and the fixed end 122 is fixed at the circuit board 13. In detail, the input device 11 of the present embodiment further includes a connecting member 112, which can be a linkage or a pivot, so that the free end 121 of the piezoelectric device 12 is movably connected with the input device 11 via the connecting member 112. The design of the connecting member 112 makes the free end 121 of the piezoelectric device 12 not completely be fixed to the input device 11 but rotatable with the linkage or the pivot as an axis.

Moreover, the circuit board 13 of the present embodiment further includes a fixing member 131. The fixed end 122 of the piezoelectric device 12 is fixed at the fixing member 131. For example, the fixing member 131 can be adhesive, a locking member or a fastener to glue, lock or fasten the fixed end 122 of the piezoelectric device 12 to the circuit board 13. Note that the fixed end 122 of the piezoelectric device 12 of the present embodiment is the end connected with the fixing member 131, and the free end 121 is the end opposite to the fixed end 122.

Moreover, the piezoelectric device 12 is disposed between the input device 11 and the circuit board 13. In the present embodiment, the circuit board 13 and input device 11 are disposed in parallel with a predetermined distance D in between. The predetermined distance D between the input device 11 and the circuit board 13 forms the space that can accommodate the piezoelectric device 12. That space is also the space required by the piezoelectric device 12 when deformation is generated. The circuit board 13 can be disposed at the housing of the electronic apparatus, such as the housing of a smartphone, or can share the circuit board of the electronic apparatus directly. Correspondingly, the input device 11 can be a press member. In the present embodiment, the input device 11 and the circuit board 13 are disposed in parallel, and the circuit board 13 is at the inner surface 111 of the input device 11 while the piezoelectric device 12 is disposed between the input device 11 and the circuit board 13. One end of the piezoelectric device 12 contacts the input device 11 and another end is electrically connected with the circuit board 13.

In detail, the piezoelectric device 12 is a component made of piezo. The piezo may be but not limited to piezoelectric ceramics or piezoelectric polymers, such as PVDF (Polyvinylidene difluoride). Piezo has the characteristic of converting between mechanical energy and electrical energy, which is called piezoelectricity. Moreover, piezoelectricity includes direct piezoelectricity and converse piezoelectricity. The direct piezoelectricity refers to the conversion of mechanical energy into electrical energy, and the converse piezoelectricity refers to the conversion of electrical energy into mechanical energy.

Furthermore, the circuit board 13 includes a processing module 132 and a power supply module 133. The processing module 132 is electrically connected with the power supply module 133. The processing module 132 of the present embodiment is electrically connected with the piezoelectric device 12, and further has a voltage-sensing unit to detect the electric potential generated by the piezoelectric device 12 due to the direct piezoelectricity. The power supply module 133 is also electrically connected with the piezoelectric device 12 to make the piezoelectric device 12 generate converse piezoelectricity.

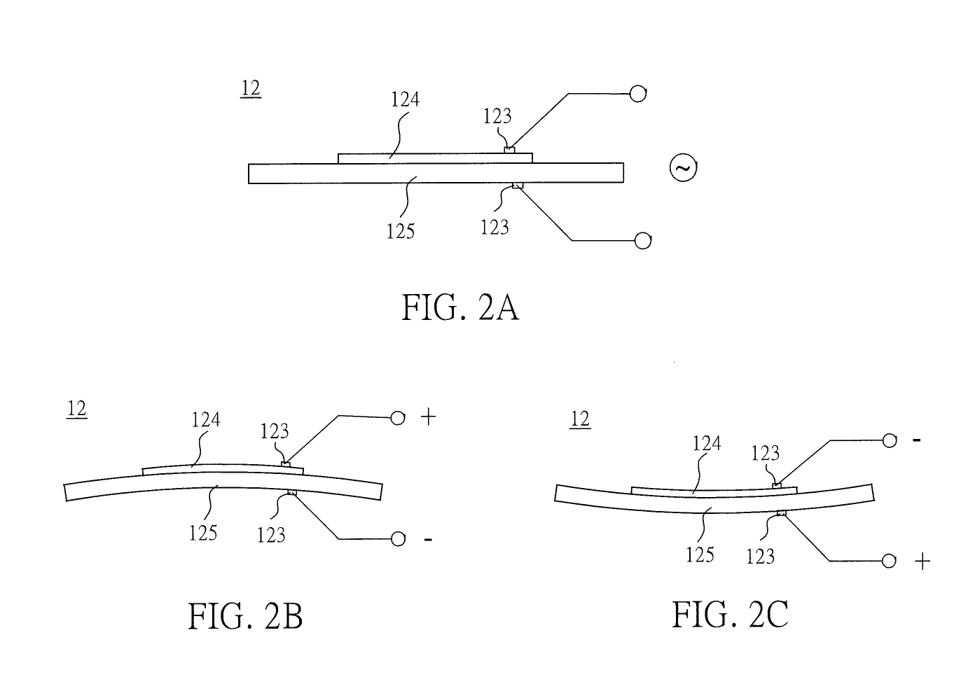

FIG. 2A is a schematic diagram of the piezoelectric device shown in FIG. 1. Referring to FIG. 1A, the piezoelectric device 12 includes at least two electrodes 123, a piezoelectric sheet 124 and a metal sheet 125. The piezoelectric sheet 124 is attached to the metal sheet 125, and the at least two electrodes 123 are disposed at the piezoelectric sheet 124 and the metal sheet 125, respectively. The polarity of the electrode 123 disposed at the piezoelectric sheet 124 and the polarity of the electrode 123 disposed at the metal sheet 125 are positive and negative, respectively. Note that the invention does not limit the number of the electrodes 123, which is at least two, and in the present embodiment the piezoelectric device 12 has two electrodes 123 for exemplary purposes. In the present embodiment, the electrodes 123 are output/input electrodes. Two electrodes 123 are disposed at the piezoelectric sheet 124 and the metal sheet 125, respectively, and the processing module 132 and the power supply module 133 are electrically connected with the two electrodes 123. In other words, the electrode 123 disposed at the piezoelectric sheet 124 is electrically connected with both the processing module 132 and the power supply module 133, and the electrode 123 disposed at the metal sheet 125 is also electrically connected with the processing module 132 and the power supply module 133.

When receiving electrical energy, the piezoelectric sheet 124 generates tensile deformation and compression deformation due to converse piezoelectricity. That is, due to the change of positive and negative polarities of alternating current, the piezoelectric sheet 124 generates tensile deformation and compression deformation, which makes the piezoelectric device 12 bend toward different directions, as shown in FIG. 2B and FIG. 2C. FIG. 2B and FIG. 2C are schematic diagrams showing the actions of the piezoelectric device shown in FIG. 2A when receiving alternating current.

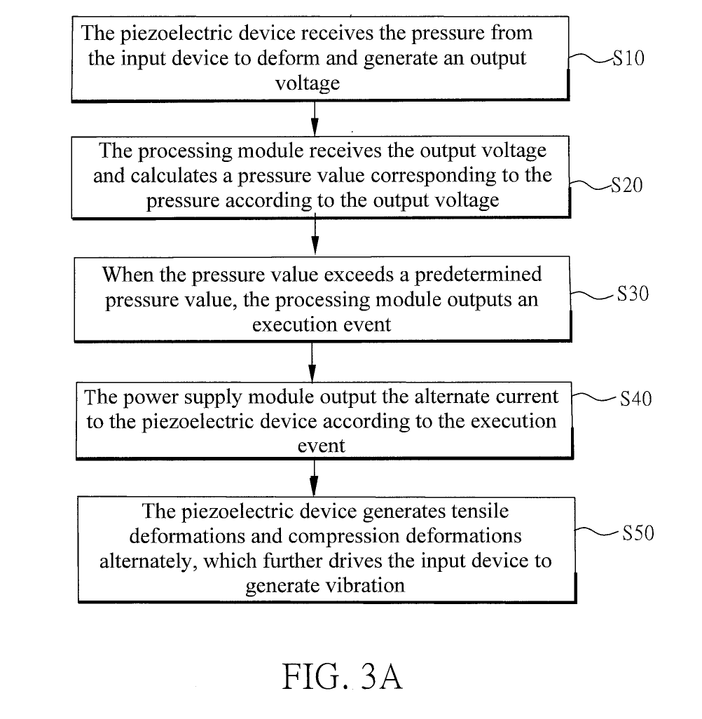

FIG. 3A is a flowchart of the touch-sensitive input method according to an embodiment of the invention. The method can be applied to the touch-sensitive input apparatus 1 of the embodiment to perform input and haptic feedback functionalities. FIG. 3B is a schematic diagram showing the touch-sensitive input apparatus shown in FIG. 1 performing the input function, and FIG. 3C is a schematic diagram showing the touch-sensitive input apparatus shown in FIG. 1 performing the haptic feedback function. Referring to FIG. 3A and FIG. 3B, with the structure of the touch-sensitive input apparatus described above, the user can apply a pressure to the input device 11 (as shown by the arrow in FIG. 3B), that is, the input action performed by the user to the input device 11 mentioned above, such as pressing the outer surface of the input device 11, and the input device 11 receives the corresponding pressure. Since one end of the piezoelectric device 12 contacts the input device 11, the piezoelectric device 12 is capable of receiving the pressure from the input device 11 to deform and generate an output voltage (step S10).

Specifically, since the free end 121 of the piezoelectric device 12 is connected with the input device 11, the free end 121 of the piezoelectric device 12 also receives the pressure from the input device 11, which further results the compression deformation of the piezoelectric device 12. Through the direct piezoelectricity of the piezoelectric device 12, the compression deformation of the piezoelectric device 12 (mechanical energy) is transformed into electrical potential (output voltage) to generate the output voltage. At this moment, the two electrodes 123 act as output electrodes to output a voltage.

Subsequently, the processing module 132 receives the output voltage and calculates a pressure value corresponding to the pressure according to the output voltage (step S20). When the pressure value exceeds a predetermined pressure value, the processing module 132 outputs an execution event (step S30). In the present embodiment, the processing module 132 can calculate the pressure value of the pressure received by the input device 11 according to the output voltage. When the pressure value exceeds a predetermined pressure value, the input action is determined to be a valid input and is not the pressure due to an accidental press. The processing module 132 can further output an execution event, so that the touch-sensitive input apparatus 1 generates a haptic feedback correspondingly.

Specifically, the execution event can control the power supply module 133 to output an alternate current to the electrodes 123 of the piezoelectric device 12, and the power supply module 133 can correspondingly output the alternate current to the electrodes 123 according to the execution event (step S40). At this moment, the piezoelectric device 12 generates tensile deformations and compression deformations alternately, which further drives the input device 11 to generate vibration (step S50). In detail, when the power supply module 132 outputs the alternate current to the electrodes 123, the electrodes 123 acts as the receiving electrodes to receive the alternate current, and the piezoelectric device 12 generates the tensile deformations and compression deformations alternately due to converse piezoelectricity. As mentioned above, the piezoelectric device 12 of the present embodiment can generate tensile and compression deformations to bend toward different directions via the characteristic of the change of the positive and negative polarities of the alternate current. FIG. 3C shows the aspects of bending in different directions using solid and phantom lines. Since one end of the piezoelectric device 12 is connected with the input device 11 and another end is fixed at the circuit board 13, and the circuit board is a fixed component, when the piezoelectric device 12 bends in different directions, the input device is driven to generate vibrations as shown by the arrows in FIG. 3C to provide the user with a haptic feedback.

Preferably, the execution event outputted by the processing module 123 can also control an output voltage and an output time interval of the alternate current to control a vibration amplitude and a vibration frequency of the piezoelectric device 12 and to further indirectly control the vibration of the input device 11 so as to generate a different haptic feedback.

Therefore, the touch-sensitive input apparatus 1 uses the characteristics of direct piezoelectricity and the converse piezoelectricity of the piezoelectric device 12. The direct piezoelectricity characteristic is used for the execution of the input function, and the converse piezoelectricity is used for the execution of the haptic feedback function.

In other embodiments, the execution event may further include opening or executing an application program. For example, the input device 11 is a touch panel, and can be used to execute an application program. If the input device 11 displays an icon of“confirm to open navigation program”, a user can press the input device 11, such as a double tap, and piezoelectric device 12 is deformed when receiving the double tap from the input device 11 to generate two corresponding output voltages. The processing module 132 receives the two output voltages, and calculates the two corresponding pressure values according to the two output voltages. When the two pressure values both exceed the predetermined pressure value, it is determined that this is a valid input. Then, the processing module 132 outputs a signal to confirm the opening or execution of the application program to open the navigation program. At this moment, the power supply module 133 can also output an alternate current to the piezoelectric device 12 according to the execution event to make the piezoelectric device 12 generate tensile and compression deformations alternately to drive the input device 11 to vibrate to notify the user that a corresponding application program is being opened or executed by a haptic feedback.

In other embodiments, the touch-sensitive input apparatus 1 can also be disposed or connected in the electronic apparatus. When the input device 11 is pressed, the piezoelectric device 12 receives the pressure and is deformed to output the output voltage. After receiving the output voltage, the processing module 132 of the circuit board 13 calculates the pressure value corresponding to the pressure according to the output voltage. When the pressure value exceeds a predetermined pressure value, an execution event is outputted correspondingly, and the output voltage and the output time interval of the alternate current outputted by the power supply module 133 is further controlled. The power supply module 133 outputs the alternate current to the piezoelectric device 12 to make the piezoelectric device 12 to generate tensile and compression deformations alternately to drive the input device 11 to vibrate to provide the user with a haptic feedback, such as to vibrate once, to confirm the execution of the navigation application program. This helps a visually impaired person to operate the electronic apparatus. This can also be applied in the car so that with the haptic feedback it is not necessary for a driver to look at the display, which improves the driving safety. Of course, the touch-sensitive input apparatus 1 of the embodiment can also be applied to other control modes, such as the adjusting the sound volume or adjusting the playback speed. Relevant descriptions are omitted here for concise purpose.

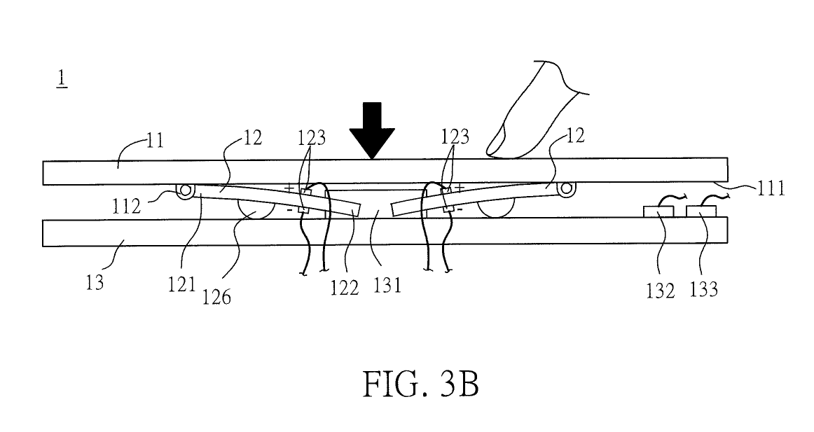

Note that the number of the electrode 123 is at least two. Please refer to FIG. 4, which is a schematic diagram showing the piezoelectric device shown in FIG. 2A according to another embodiment. The piezoelectric device 12d has four electrodes, including two first electrodes 123d and two second electrodes 123e. The two first electrodes 123d are disposed at the metal sheet 125 and the piezoelectric sheet 124, respectively, and the two second electrodes 123e are disposed at the piezoelectric sheet 124 and the metal sheet 125, respectively. The processing module 132 is electrically connected with the two first electrodes 123d, and the power supply module 133 is electrically connected with the two second electrodes 123e. The first electrodes 123d electrically connected with the processing module 132 are input electrodes, which receive the output voltage from the piezoelectric device 12. The second electrodes 123e electrically connected with the power supply module 133 are output electrodes, which output the alternate current to the piezoelectric device 12. This arrangement achieves the same effect to the previous embodiment. Note that for concise purpose, components that can be referred to in FIG. 1, such as the input device 11 and the circuit board 13, are omitted in FIG. 4 for concise purpose.

Referring back to FIG. 1, preferably, the piezoelectric device 12 of this embodiment can further include a weight member 126 disposed between the free end 121 and the fixed end 122 and also between the connecting member 112 and the fixing member 131. With the disposition of the weight member 126, the vibration amplitude of the piezoelectric device 12 can be increased. Therefore, the vibration of the input device 11 driven by the alternate tensile and compression deformations of the piezoelectric device 12 is more significant.

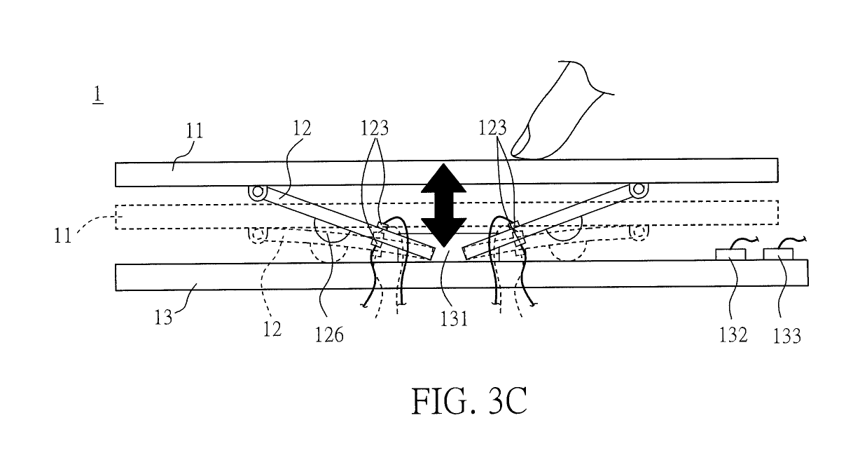

The touch-sensitive input apparatus 1 of the invention may have other aspects as shown in FIG. 5 to FIG. 7, which will be described hereinbelow.

FIG. 5 is a schematic diagram shown the touch-sensitive input apparatus according to a second embodiment of the invention. Referring to FIG. 5, the touch-sensitive input apparatus 1a of the present embodiment has a plurality of circuit boards 13a disposed at the outside of the input device 11a. Only a portion of each circuit board 13a overlaps with the inner surface 111a of the input device 11a. The touch-sensitive input apparatus 1a of the present embodiment has a plurality of piezoelectric devices 12a, and each piezoelectric device 12a has a free end 121a and a fixed end 122a. The free end 121a and the fixed end 122a are provided at two opposite ends of the piezoelectric device 12a. The input device 11a further includes a plurality of connecting members 112a, and the free end 121a of each piezoelectric device 12a is movably connected with the corresponding connecting member 112a. Each circuit board 13a further includes a fixing member 131a, and the fixed end 122a of each piezoelectric device 12a is fixed at the corresponding fixing member 131a of the circuit board 13a. The free end 131a of each piezoelectric device 12a can receive the pressure from the input device 11a to make the corresponding piezoelectric device 12a be compressively deformed, so that the piezoelectric device 12a utilizes the direct piezoelectricity to convert the compression deformation (mechanical energy) into the electrical potential (the output voltage) to generate an output voltage.

In the present embodiment, a weight member 126a is disposed between the free end 121a and the fixed end 122a of each piezoelectric device 12a. That is, the weight member 126a is disposed between the connecting member 112a and the fixing member 131a. When the power supply module 133 (referring to FIG. 1) provides an alternate current to the corresponding electrode 123 so that the corresponding piezoelectric device 12a generates tensile and compression deformations alternately due to the converse piezoelectricity, the weight member 126a disposed between the free end 121a and the fixed end 122a can increase the bending magnitude of the piezoelectric device 12a, so that the vibration of the input device 11a can be more significant. The technical details and connection relationships of the other components of the touch-sensitive input apparatus 1a can be referred to the touch-sensitive input apparatus 1 of the first embodiment and the steps S10 to S30 shown in FIG. 3A, which descriptions are omitted here for concise purpose.

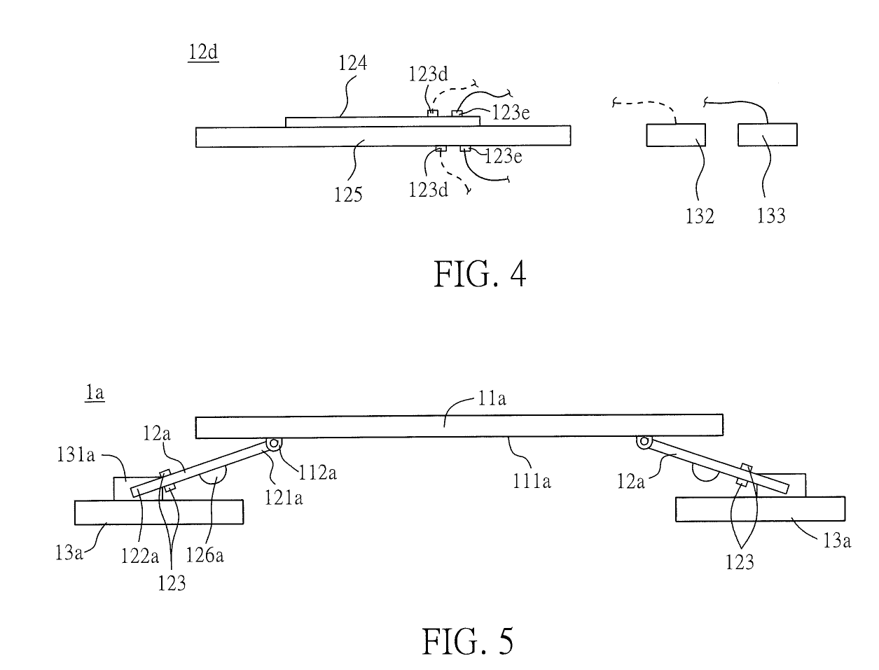

FIG. 6 is a schematic diagram showing the touch-sensitive input apparatus according to a third embodiment of the invention. Referring to FIG. 6, in the touch-sensitive input apparatus 1b of the present embodiment, the piezoelectric device 12b also has a free end 121b and a fixed end 122b, and the free end 121b and the fixed end 122b are provided at two opposite ends of the piezoelectric device 12b. In the present embodiment, the fixed end 122b is fixed at the input device 11b, and the circuit board 13b is connected between the free end 121b and the fixed end 122b. Therefore, the fixed end 122b of the piezoelectric device 12b can receive the pressure from the input device 11b and can be compressively deformed. The piezoelectric device 12b utilizes the direct piezoelectricity to convert the compression deformation (mechanical energy) into electrical potential (output voltage) to generate an output voltage.

In the present embodiment, the input device 11b further includes a fixing member 113b. The fixed end 122b of the piezoelectric device 12b is fixed at the fixing member 113b. The fixing member 113b of the present embodiment can be adhesive to glue the fixed end 122b of the piezoelectric device 12b to the input device 11b. The circuit board 13b of the present embodiment includes a connecting member 134b connected with the piezoelectric device 12b between the free end 121 and the fixed end 122b. The free end 121b is not connected with the input device 11b and the circuit board 13b, thus can move freely along with the tensile and compression deformations of the piezoelectric device 12b.

Furthermore, the piezoelectric device 12b further includes a weight member 126b directly disposed at the free end 121b of the piezoelectric device 12b. Therefore, when the power supply module 133 (referring to FIG. 1) provides an alternate current to the to the corresponding electrode 123 so that the piezoelectric device 12b generates tensile and compression deformations alternately due to the converse piezoelectricity, the weight member 126b disposed at the end (the free end 121b) can increase the bending magnitude of the piezoelectric device 12b, so that the vibrations of the input device 11b can be more significant. The technical details and connection relationships of the other components of the touch-sensitive input apparatus 1b can be referred to the previous embodiments and the steps S10 to S30 shown in FIG. 3A, which descriptions are omitted here for concise purpose.

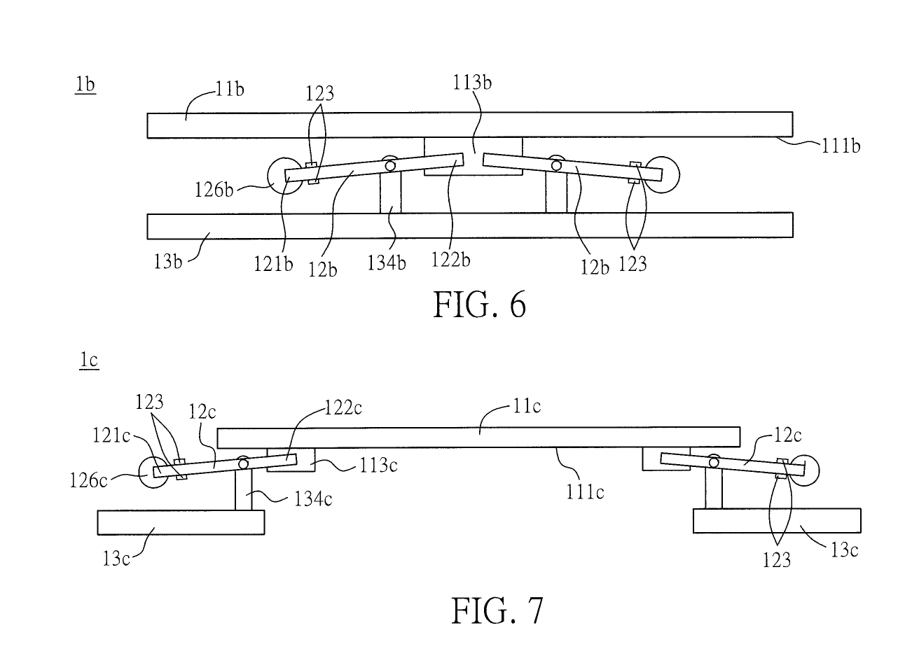

FIG. 7 is a schematic diagram showing the touch-sensitive input apparatus according to a fourth embodiment of the invention. Referring to FIG. 7, the touch-sensitive input apparatus 1c of the present embodiment has a plurality of circuit boards 13c disposed at the outside of the input device 11c similar to the second embodiment. The present embodiment has a plurality of piezoelectric device 12c, and each piezoelectric device 12c also has a free end 121c and a fixed end 122c. The free end 121c and the fixed end 122c are provided at opposite ends of the piezoelectric device 12c. Each circuit board 13c further includes a connecting member 134c connected between the free end 121c and the fixed end 122c of the corresponding piezoelectric device 12c. The input device 11c further includes a plurality of fixing members 133c. The fixed end 122c of each piezoelectric device 12c is fixed at the corresponding fixing member 113c, and the fixed end 122c of each piezoelectric device can receive the pressure from the input device 11c to make the corresponding piezoelectric device 12c be compressively deformed. The piezoelectric device 12c utilizes the direct piezoelectricity to convert the compression deformation (mechanical energy) into electrical potential (output voltage) to generate an output voltage.

As described previously, the weight member 126c is disposed at the free end 121c of the piezoelectric device 12c. Therefore, when the power supply module 133 (referring to FIG. 1) provides an alternate current to the corresponding electrode 123, the bending magnitude of the piezoelectric device 12c due to the converse piezoelectricity can be increased, and the vibrations of the input device 11c can be more significant. The technical details and connection relationships of the other components of the touch-sensitive input apparatus 1a can be referred to the touch-sensitive input apparatus 1 of the first embodiment and the steps S10 to S30 shown in FIG. 3A, which descriptions are omitted here for concise purpose.

Note that for concise purpose, the technical details and connection relationships of components that can be referred to the previous embodiment and FIG. 1, such as the processing module 132, the power supply module 133 and the electrodes 123, are omitted in FIG. 5 to FIG. 7 for concise purpose.

To sum up, according to the touch-sensitive input apparatus and the electronic apparatus having the touch-sensitive input apparatus of the invention, an input action at the input device is detected by making the piezoelectric device contact the input device and be connected with the circuit board to convert the mechanical energy (the compression deformation due to the pressure from the input device) into electrical potential (output voltage), and a haptic feedback is achieved by using the piezoelectric device to convert the electric potential into mechanical energy (tensile and compression deformations) to make the input device generate vibrations. Therefore, the input device of the invention achieves the two functions of input action detection and haptic feedback simultaneously using the piezoelectric device to replace conventional force sensors and actuators, which saves spaces and reduces material costs.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch-sensitive input apparatus, comprising:
an input device;
at least one piezoelectric device contacting the input device, the at least one piezoelectric device being capable of receiving a pressure from the input device to deform and generate an output voltage; and
a circuit board electrically connected with the at least one piezoelectric device, the circuit board comprising:
a processing module electrically connected with the at least one piezoelectric device and receiving the output voltage, the processing module calculating a pressure value corresponding to the pressure according the output voltage, and outputting an execution event when the pressure value exceeding a predetermined pressure value; and
a power supply module electrically connected with the processing module and the at least one piezoelectric device, the power supply module outputting an alternate current to the at least one piezoelectric device according to the execution event, so that the at least one piezoelectric device generates tensile deformations and compression deformations alternately to drive the input device to generate vibration.

2. The touch-sensitive input apparatus according to claim 1, wherein the execution event comprises opening an application program.

3. The touch-sensitive input apparatus according to claim 1, wherein the execution event comprises controlling an output voltage and an output time interval of the alternate current to control a vibration amplitude and a vibration frequency of the piezoelectric device.

4. The touch-sensitive input apparatus according to claim 1, wherein the piezoelectric device comprises a piezoelectric sheet, at least two electrodes and a metal sheet, the piezoelectric sheet is attached to the metal sheet, and the at least two electrodes are disposed at the piezoelectric sheet and the metal sheet, respectively.

5. The touch-sensitive input apparatus according to claim 4, wherein the piezoelectric device has two electrodes, the two electrodes are disposed at the piezoelectric sheet and the metal sheet, respectively, and the processing module and the power supply module are electrically connected with the two electrodes.

6. The touch-sensitive input apparatus according to claim 4, wherein the piezoelectric device has four electrodes, the four electrodes includes two first electrodes and two second electrodes, the two first electrodes are disposed at the piezoelectric sheet and the metal sheet, respectively, the two second electrodes are disposed at the piezoelectric sheet and the metal sheet, respectively, the processing module is electrically connected with the two first electrodes, and the power supply module is electrically connected with the two second electrodes.

7. The touch-sensitive input apparatus according to claim 4, wherein the polarity of the at least one electrode disposed at the piezoelectric sheet and the polarity of the at least one electrode disposed at the metal sheet are positive and negative, respectively.

8. The touch-sensitive input apparatus according to claim 1, wherein the piezoelectric device comprises a free end and a fixed end, the free end is movably connected with the input device, the fixed end is fixed at the circuit board, and the free end of the piezoelectric device is capable of receiving the pressure from the input device whereby the piezoelectric device is compressively deformed.

9. The touch-sensitive input apparatus according to claim 8, wherein the input device further comprises a connecting member, the free end of the piezoelectric device is movably connected with the connecting member, the circuit board further comprises a fixing member, and the fixed end of the piezoelectric device is fixed at the fixing member.

10. The touch-sensitive input apparatus according to claim 8, wherein the piezoelectric device further comprises a weight member disposed between the free end and the fixed end.

11. The touch-sensitive input apparatus according to claim 1, wherein the piezoelectric device comprises a free end and a fixed end, the fixed end is fixed at the input device, the free end is disposed opposite to the fixed end, the circuit board is connected between the free end and the fixed end, and the fixed end of the piezoelectric device is capable of receiving the pressure from the input device whereby the piezoelectric device is compressively deformed.

12. The touch-sensitive input apparatus according to claim 11, wherein the circuit board further comprises a connecting member, the connecting member is connected with the piezoelectric device, and the connecting member is connected between the free end and the fixed end, the input device further comprises a fixing member, the fixed end of the piezoelectric device is fixed at the fixing member.

13. The touch-sensitive input apparatus according to claim 12, wherein the piezoelectric device further comprises a weight member disposed at the free end of the piezoelectric device.

14. The touch-sensitive input apparatus according to claim 1, wherein the input device is a touchpad or a touch panel.

15. An electronic apparatus, comprising:
a touch-sensitive input apparatus, comprising:
an input device,
at least one piezoelectric device contacting the input device, the at least one piezoelectric device being capable of receiving a pressure from the input device to deform and generate an output voltage; and
a circuit board electrically connected with the at least one piezoelectric device, the circuit board comprising:
a processing module electrically connected with the at least one piezoelectric device and receiving the output voltage, the processing module calculating a pressure value corresponding to the pressure according the output voltage, and outputting an execution event when the pressure value exceeding a predetermined pressure value; and
a power supply module electrically connected with the processing module and the at least one piezoelectric device, the power supply module outputting an alternate current to the at least one piezoelectric device according to the execution event, so that the at least one piezoelectric device generates tensile deformations and compression deformations alternately to drive the input device to generate vibration.

16. The electronic apparatus according to claim 15, wherein the execution event comprises opening an application program.

17. The electronic apparatus according to claim 15, wherein the execution event comprises controlling an output voltage and an output time interval of the alternate current to control a vibration amplitude and a vibration frequency of the piezoelectric device.

18. The electronic apparatus according to claim 15, wherein the piezoelectric device comprises a piezoelectric sheet, at least two electrodes and a metal sheet, the piezoelectric sheet is attached to the metal sheet, and the at least two electrodes are disposed at the piezoelectric sheet and the metal sheet, respectively.

19. The electronic apparatus according to claim 18, wherein the piezoelectric device has two electrodes, the two electrodes are disposed at the piezoelectric sheet and the metal sheet, respectively, and the processing module and the power supply module are electrically connected with the two electrodes.

20. The electronic apparatus according to claim 18, wherein the piezoelectric device has four electrodes, the four electrodes includes two first electrodes and two second electrodes, the two first electrodes are disposed at the piezoelectric sheet and the metal sheet, respectively, the two second electrodes are disposed at the piezoelectric sheet and the metal sheet, respectively, the processing module is electrically connected with the two first electrodes, and the power supply module is electrically connected with the two second electrodes.

21. The electronic apparatus according to claim 18, wherein the polarity of the at least one electrode disposed at the piezoelectric sheet and the polarity of the at least one electrode disposed at the metal sheet are positive and negative, respectively.

22. The electronic apparatus according to claim 15, wherein the piezoelectric device comprises a free end and a fixed end, the free end is movably connected with the input device, the fixed end is fixed at the circuit board, and the free end of the piezoelectric device is capable of receiving the pressure from the input device whereby the piezoelectric device is compressively deformed.

23. The electronic apparatus according to claim 22, wherein the input device further comprises a connecting member, the free end of the piezoelectric device is movably connected with the connecting member, the circuit board further comprises a fixing member, and the fixed end of the piezoelectric device is fixed at the fixing member.

24. The electronic apparatus according to claim 23, wherein the piezoelectric device further comprises a weight member disposed between the free end and the fixed end.

25. The electronic apparatus according to claim 15, wherein the piezoelectric device comprises a free end and a fixed end, the fixed end is fixed at the input device, the free end is disposed opposite to the fixed end, the circuit board is connected between the free end and the fixed end, and the fixed end of the piezoelectric device is capable of receiving the pressure from the input device whereby the piezoelectric device is compressively deformed.

26. The electronic apparatus according to claim 25, wherein the circuit board further comprises a connecting member, the connecting member is connected with the piezoelectric device, and the connecting member is connected between the free end and the fixed end, the input device further comprises a fixing member, the fixed end of the piezoelectric device is fixed at the fixing member.

27. The electronic apparatus according to claim 26, wherein the piezoelectric device further comprises a weight member disposed at the free end of the piezoelectric device.

28. The electronic apparatus according to claim 15, wherein the input device is a touchpad or a touch panel.

29. A touch-sensitive input method for a touch-sensitive input apparatus, the touch-sensitive input apparatus comprising an input device, at least one piezoelectric device and a circuit board, one end of the piezoelectric device contacting the input device, another end being electrically connected with the circuit board, the circuit board comprising a processing module and a power supply module, the touch-sensitive input method comprising the steps of:
the piezoelectric device receiving a pressure from the input device to deform and generate an output voltage;
the processing module receiving the output voltage and calculating a pressure value corresponding to the pressure according the output voltage;
the processing module outputting an execution event when the pressure value exceeding a predetermined pressure value;
the power supply module outputting an alternate current to the piezoelectric device according to the execution event; and
the piezoelectric device generating tensile deformations and compression deformations alternately to drive the input device to generate vibration.
